(19) United States
(12) Patent Application Publication
(10) Pub. No.: US 2025/0332774 A1
(43) Pub. Date: Oct. 30, 2025

(54) HEATED RUNNER SEPARATOR

(71) Applicant: Moxietec, LLC, Grove City, PA (US)

(72) Inventors: Abolfazl Mohebbi, Grove City, PA (US); Robert Alan Sickles, JR., Carlton, PA (US); Glen Robert Thomas, Pulaski, PA (US)

(21) Appl. No.: 19/194,489

(22) Filed: Apr. 30, 2025

Related U.S. Application Data
(60) Provisional application No. 63/640,625, filed on Apr. 30, 2024.

(51) Int. Cl. B29C 45/27

(52) U.S. Cl. CPC B29C 45/2737; B29C 45/2756; B29C 2045/274; B29C 2045/2751; B29C 2045/2795; B29C 2945/7604; B29C 2945/76274; B29C 2945/76381; B29C 2945/76531

(57) ABSTRACT

Disclosed herein is apparatus and methods for separating plastic runners in a cold runner system between injection cycles of an injection molding process. In one exemplary embodiment, the apparatus is a heated runner separator that includes a heated melt disc with a central aperture, a heating band positioned around the heated melt disc, a first insulator ring positioned proximate to a first end of the central aperture of the heated melt disc, and a second insulator ring positioned proximate to a second and opposite end of the central aperture of the heated melt disc. The heated runner separator further includes a first terminal and second terminal extending from the heating band and arranged to couple to a heating source to heat the heating band. The heated runner separator further includes a thermocouple in contact with the heated melt disc and arranged to measure the temperature of the heated melt disc.

### CROSS-REFERENCE TO RELATED APPLICATIONS

The present application claims priority to U.S. Provisional Application Ser. No. 63/640,625, titled “Heated Runner Separator,” filed Apr. 30, 2024, which is fully hereby incorporated by reference herein.

### FIELD OF INVENTION

The present disclosure generally relates to an apparatus and method for separating a section of a plastic runner in a cold runner system during an injection molding process. More specifically, the present disclosure relates to a heated runner separator apparatus that is positioned around a section of a branch of the cold runner system and proximate to injection points to separate a section of the plastic runners by managing and localizing the application of heat to the plastic runners in between injection cycles of an injection molding process and methods for using same.

### BACKGROUND

An injection molding system includes an injection molding machine, a mold, and a one or more mold cavities inside the mold. Injection molding is a method that includes heating up a thermoplastic polymer in the injection molding machine until the thermoplastic polymer is in a molten state. The injection molding machine then applies pressure to the molten thermoplastic polymer to inject the thermoplastic polymer into the mold cavities, which defines the shape and contours of the desired final molded part(s). Once the mold cavities are filled with molten thermoplastic polymer, the mold cavities are cooled and the plastic parts are solidified. The molten thermoplastic polymer typically flows from the molding machine to the mold cavity through a nozzle, sprue, and one or more runners. A sprue is a flow path for molten plastic to travel from the injection molding machine nozzle to the mold, and runners are flow paths through the mold by which the molten plastic flows into the mold cavity.

FIGS. 1 and 2 schematically illustrate a simplified injection molding assembly 10 with an injection molding machine 12 and a two plate mold 14 for use in an injection molding process to form two final molded parts. FIG. 1 illustrates the injection molding assembly at the beginning of an injection molding cycle, and FIG. 2 illustrates the injection molding assembly at the end of of an injection molding cycle. The mold 14 includes a first plate 16 and second plate 18 that form two mold cavities 20 between the plates 16, 18. The first plate 16 is often referred to as the “A-side” of the mold cavity, and the second plate 18 is often referred to as the “B-side of the mold cavity. The injection molding machine 12 injects molten plastic in the form of a shot 22 through the nozzle 24, through a sprue 26, through the runners 28, and into the mold cavities 20. FIG. 2 illustrates the solidified formed parts 30. The terms “sprue” and “runner” as used in this application will mean the physical structure that forms the passageways between the injection molding machine and the mold cavities. The terms “plastic sprue” and “plastic runners” will mean the plastic material within the sprue or runner respectively.

Traditionally, there are two types of runner systems used in injection molding, hot runner systems and cold runner systems. A hot runner system includes a heated nozzle and heated manifold positioned between the injection molding machine and mold cavities that keeps the plastic sprue and plastic runners in the sprue and runner system in a molten state in between injection cycles. With hot runner systems, only the final plastic part in the mold cavity is cooled, all upstream components and plastic remain at elevated temperatures during a production run, and the plastic remains in a molten state. In a cold runner system, the sprue and runners are cooled at the same time as the mold cavity is cooled. In between each injection cycle, the plastic sprue and plastic runner in the sprue and runner system solidifies and is ejected along with the molded final part.

Cold runner systems for producing the parts with multiple injection points often use a three plate mold design. The additional plate is located between the injection molding machine and plates that form the mold cavities and is used to separate the plastic sprue and plastic runner from the molded and solidified part. These cold runner systems typically include a section of the runner that has a decreased diameter (i.e., the runner is “necked-down” at one location) to weaken the plastic runner at that necked-down point to make it easier for the plastic runner to be separated from the molded part when the third plate separates from the plates forming the mold cavities. FIG. 3 schematically illustrates a simple three plate mold that includes a first plate (A-side of mold cavities) 32, a second plate (B-side of cavity) 34, and a runner stripper plate 36. As illustrated, the first 32 and second 34 plates include cavities that form two parts 38. As the two parts 38 are cooled and solidified, the plastic sprue 40 in the sprue 42 and plastic runner 44 in the runner 46 are cooled and solidify as well. An extension of the runner (commonly known as an injection point, gate, or drop) 48 extends from the runner 46 to the mold cavities 50. A section of the injection point 48 is narrowed or necked-down at the intersection of the injection point 48 and mold cavities 50 (the necked-down region identified as reference no. 52). When the runner stripper plate 36 is separated from the first mold plate 32, the plastic runner 42 breaks at the intersection 52 and the plastic sprue 40 and plastic runner 44 separate from the molded parts 38 and can be discarded.

While hot runner systems have certain advantages, there are significant downsides to hot runner systems, particularly when the injection molding process includes foaming of a thermoplastic polymer use to form a finished part. Hot runner systems are expensive to manufacture and maintain. It is common for hot runner systems used for large size molds with multiple injection points for molding multiple parts to cost in excess of $100,000 to manufacture. In one example a hot runner system with eight injection points costs about $200,000 to manufacture. Hot runner systems also cause additional wear and tear on the injection molding system as a whole as compared to cold runner systems, which increases maintenance costs and downtime for the injection molding machine. Hot runner systems are customized to each specific injection molding processes; therefore, additionally increasing the costs of injection molding processes that use hot runner systems because the hot runner system cannot be reused or retooled for subsequent applications. Furthermore, the complexity of hot runner systems often necessitate customizations to the molded part such as the inclusion of addition of features to the molded parts to accommodate injection points required by the hot runner system. This can result in additional plastic needed to mold the parts, thus increasing costs, and the inclusion of non-functional features to incorporated into the molded part, which can limit the intended functionality of the finished part.

Hot runner systems are particularly problematic for injection molding processes that include foaming techniques designed to reduce the density of the molded parts and/or form beneficial structures for the molded parts. At least a portion of the foaming process occurs in the injection molding machine and is enhanced through mixing of the plastic. Therefore, when foamed plastics are located in the hot runners or manifold in between injection cycles, where no mixing takes place, the foaming properties tend to dissipate since the gas molecules which saturated into the molten plastic through the mixing process within the injection molding machine start escaping from the bulk of the molten plastic. Such dissipation of the foaming properties increases the density of resulting molded component, which is the opposite of the desired result. In certain injection molding processes with thick-wall parts, the time between injections can be as much as 5-10 minutes and as much as 10% of the shot size can be located in the hot runners and manifold in between injection cycles. In addition to the general degradation of foaming properties, the plastic in the hot runners form a flow front with different properties than the remainder of the shot. This flow front is typically pushed to the far end of the mold cavity and does not mix with the remainder of the shot, which results in a final part with uneven physical and structural properties. This is typically an undesirable result.

Furthermore, hot runner systems are not suitable for all plastics due to the additional time that the plastic is at an elevated temperature in the hot runner system. Certain heat sensitive plastics, such as PVC, CPVC, and PVDF, degrade when exposes to prolonged heat, which results in inferior final molded parts. Hot runner systems also are difficult to clean during material switch overs. This is particularly true for when the material switch over includes a different color plastic.

Prior art cold runner systems can also be problematic for injection molding processes that include foaming techniques. Specifically, any portion of the cold runner system that is necked-down (such as section 52 illustrated in FIG. 3) is likely to cause molten plastic flowing past that reduced area to reduce or lose foaming properties. When a molten plastic passes a necked-down section, the pressure applied to the molten plastic is increased, which will cause gas molecules saturated into the molten plastic in the mixing process to escape from the molten plastic, thus, dissipating the desired properties of a foamed plastic.

There is a need for novel apparatus and methods for managing the flow of plastics in injection molding processes that overcome the downsides to hot runner and cold runner systems. This is particularly true for injection molding processes that use foaming techniques. Such apparatus and methods for use with modified cold runner systems in injection molding processes are described and illustrated herein.

### SUMMARY

Disclosed herein is apparatus and methods for separating plastic runners in a cold runner system between injection cycles of an injection molding process using, but not limited to, three plate molds. In one exemplary embodiment, the apparatus is a heated runner separator that includes a heated melt disc with a central aperture, a heating band positioned around the heated melt disc, a first insulator ring positioned proximate to a first end of the central aperture of the heated melt disc, and a second insulator ring positioned proximate to a second and opposite end of the central aperture of the heated melt disc. The heated runner separator can further include a first terminal and a second terminal extending from the heating band and arranged to be coupled to a heating source to heat the heating band. The heated runner separator can further include a thermocouple in contact with the heated melt disc and arranged to measure the temperature of the heated melt disc. The heated runner separator can further include a controller in communication with the thermocouple and the heating source and arranged to compare the temperature of the heated melt disc to a target temperature and (i) if the temperature of the heated melt disc is lower than the target temperature, send a signal to the heating source to apply heat to the heating band; and (ii) if the temperature of the heated melt disc is higher than the target temperature, send a signal to the heating source to cease the application of heat to the heating band.

In certain embodiments, the heated runner separator further includes an insulator layer wrapped around the outer surface of the heating band. Additionally, a pair of insulator panels can be added to the exposed faces of the heated runner separator. In certain embodiments, the heated melt disc includes an annular protrusion on each side of the heated melt disc extending outward from the edge of the central aperture. In association with this embodiment, the insulator ring can include an internal circumferential recession on one end of the insulator ring. The end of the insulator ring with the internal circumferential recession is positioned in contact with the heated melt disc. The internal circumferential recession is arranged to accommodate the annular protrusion.

A method of separating a plastic runner in a cold runner system during an injection molding process includes the steps of: positioning a heated runner separator around a runner in a mold of an injection molding system; insulating the heated runner separator to limit the transfer of heat from the heated runner separator to other portions of the injection molding system; and maintaining the heated runner separator at a temperature that will maintain plastic in the runner proximate to the heated runner separator in at least a semi-molten state, wherein when plates of the mold are separated, the plastic runner separates at a location proximate to the heated runner separator. In certain embodiments, the heated runner separator is positioned proximate to an injection point of the mold.

### BRIEF DESCRIPTION OF THE DRAWINGS

In the accompanying drawings, structures are illustrated that, together with the detailed description provided below, describe example embodiments of the disclosed systems, methods, and apparatus. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 schematically illustrates an injection molding system with a two plate mold prior to the forming of parts.

FIG. 2 schematically illustrates an injection molding system with a two plate mold after the forming of a pair of parts.

FIG. 3 schematically illustrates an injection molding system with a three plate mold after the forming of a pair of parts.

FIG. 4 schematically illustrates an injection molding system with a cold runner system and a pair of heated runner separators.

FIG. 5 schematically illustrate a perspective view of a heated runner separator.

FIG. 6 schematically illustrate another perspective view of a heated runner separator.

FIG. 7 schematically illustrate an exploded view of a heated runner separator.

FIG. 8 schematically illustrates an alternative insulator ring.

FIG. 9 is an exploded view of the alternative insulator ring of FIG. 8 and a heated melt disc, with the insulator ring slighted tilted to show an internal circumferential recession feature of the insulator ring.

FIG. 10 schematically illustrates a perspective view of a mold plate machined to accommodate three heated runner separators

FIG. 11 schematically illustrates three heated runner separators inserted into a mold plate.

FIG. 12 is a photograph of eight heated runner separators positioned in a mold plate.

FIG. 12A is a detailed view of FIG. 11.

FIG. 13 is a photograph of four plastic runner samples separated through use of a heated runner separator.

FIG. 14 schematically illustrates a cross-sectional view of a heated runner separator with an insulator layer.

FIG. 15 schematically illustrates a cross-sectional view of a heated runner separator with an insulator layer and insulator panels.

FIG. 16 schematically illustrates a cross-sectional view of a heated runner separator with an insulator layer, insulator panels, and a tapered heated melt disc.

### DETAILED DESCRIPTION

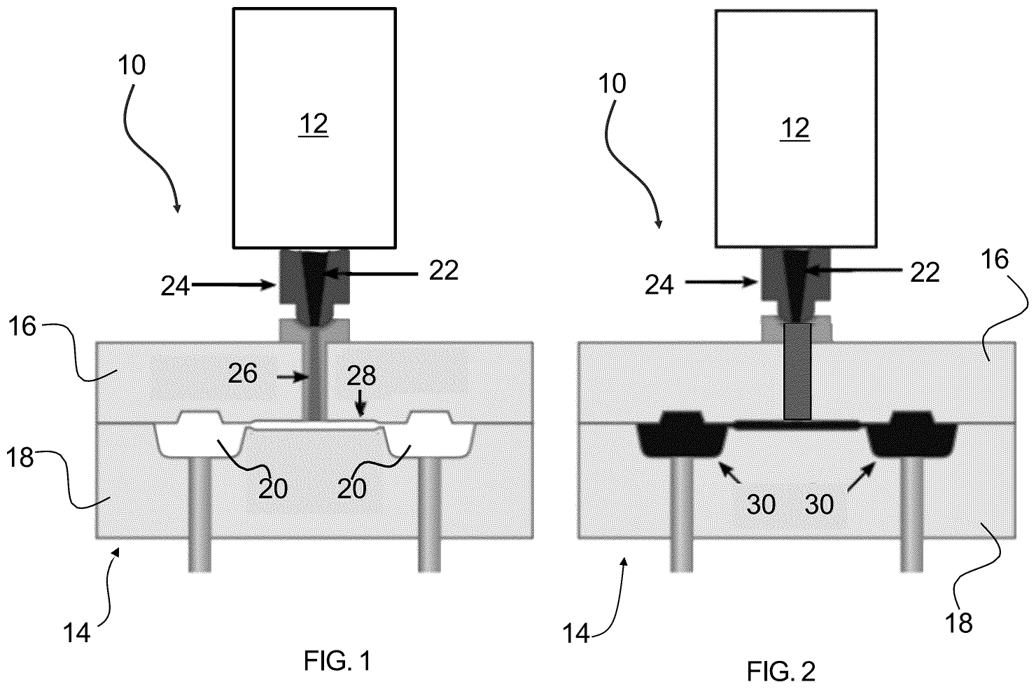

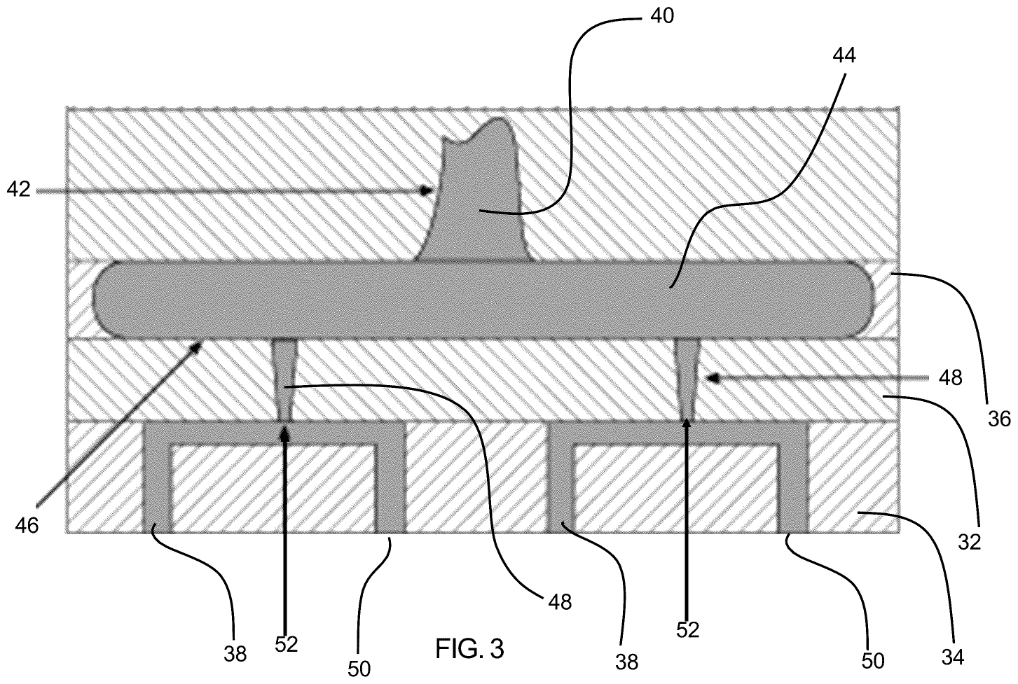

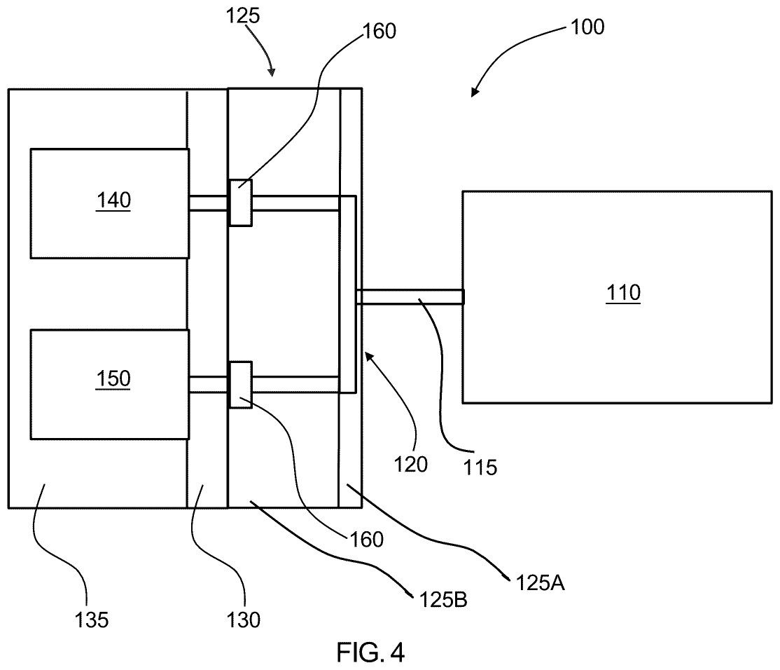

The apparatus, systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of a heated runner separator for separating plastic runners in a cold runner system in between injection cycles of an injection molding process are hereinafter disclosed and described in detail with reference made to FIGS. 1 through 16.

The present disclosure describes apparatus and methods for separating a plastic runner located in a runner between cycles of an injection molding process that employs a cold runner system. Such separation of the plastic runners provides for molded parts to be ejected from the mold cavity in between injection cycles. As used herein, the terms “separate a plastic runner,” “separating a plastic runner,” or similar terms means that at the end of an injection molding cycle, when the finished molded part is ejected or otherwise removed from the mold cavity, a plastic runner breaks or otherwise separates into two or more sections at a location proximate to the heated runner separator.

The novel apparatus is a heated runner separator that manages heat applied to the plastic runner to localize the application of such heat such that only a small section of the plastic runner remains molten or semi-molten at the end of an injection molding cycle. Novel methods include the use of such a novel apparatus. When a section of the plastic runner is referred to as molten or semi-molten, this means that the section of the plastic runner is in a condition to be separated.

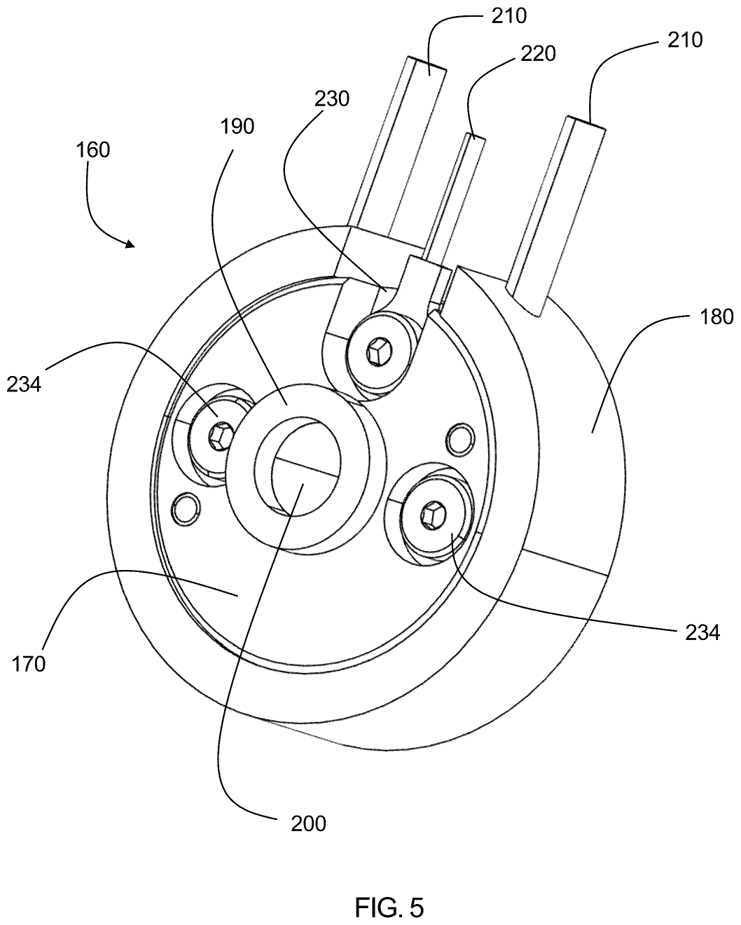

FIG. 4 schematically illustrates an overview of an injection molding system 100 that includes an injection molding machine 110, a sprue 115, a cold runner system 120, a runner stripper plate 125, a first mold plate 130 (often referred to as the “A-side”), a second mold plate 135 (often referred to as the “B-side”), a pair of mold cavities 140, 150 formed by the first 130 and second 135 mold plates for molding a pair of parts, and a pair of heated runner separators 160. Each heated runner separator 160 is positioned at or proximate to the intersection of the first mold plate 130 and one of the runners of the cold runner system 120. As will be appreciated, in between injection molding cycles, the plastic runner in a prior art cold runner system is cooled and solidifies. The plastic runner is then ejected, breaking at a necked-down section during ejection. However, with the novel apparatus and methods described herein, as will be described in detail, the addition of heated runner separators 160 significantly improves a prior art cold runner system and avoids the downsides of a hot runner system.

Each heated runner separator 160 is position such that it surrounds a relatively small section of the cold runner system 120. The heated runner separator 160 applies localized heat to the plastic runner in the cold runner system 120 such that a relatively small section of the plastic runner remains molten or semi-molten during the cooling cycle. When the cooling cycle is completed and the molded part is ejected, the small, still molten or semi-molten section of the plastic runner stretches a relatively small amount and breaks, allowing the plastic runners and molded part to be ejected separately. In essence, the heated runner separator functionally replaces the necked-down section of the runner system (i.e., at the injection point) and maintains the foaming properties of the molten plastic passing through the runner system 120 into the mold cavities 140, 150 during the injection process. It is noted that in this embodiment, the runner stripper plate 125 is divided into two sections 125A, 125B that separate during ejection of the plastic runner and plastic sprue to make such ejection more consistent and repeatable.

While FIG. 4 illustrates an injection molding system that forms a pair of parts, it will be understood that the heated runner separators 160 can be used with many different arrangements of molds. For example, the heated runner separator 160 can be used with a single part that has multiple injection points wherein the flow of the molten plastic from the sprue is divided into multiple runners to reach such injection points. Furthermore, the heated runner separator 160 can be used on highly complex molds that include horizontal and vertical injection points for one or more parts. In essence, a heated runner separator 160 can be applied to each injection point in any mold and achieve the results described herein.

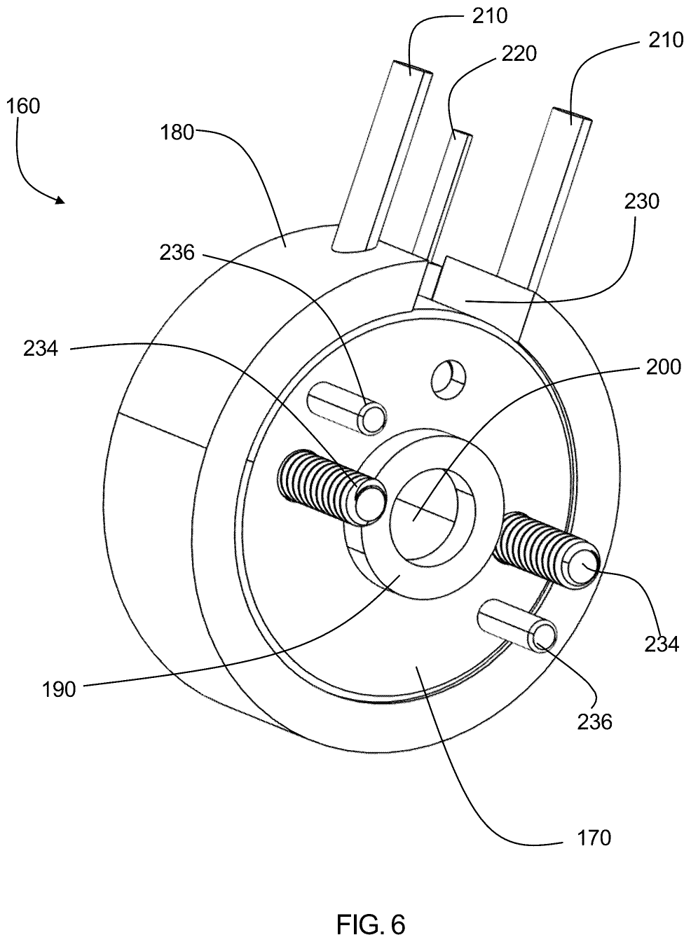

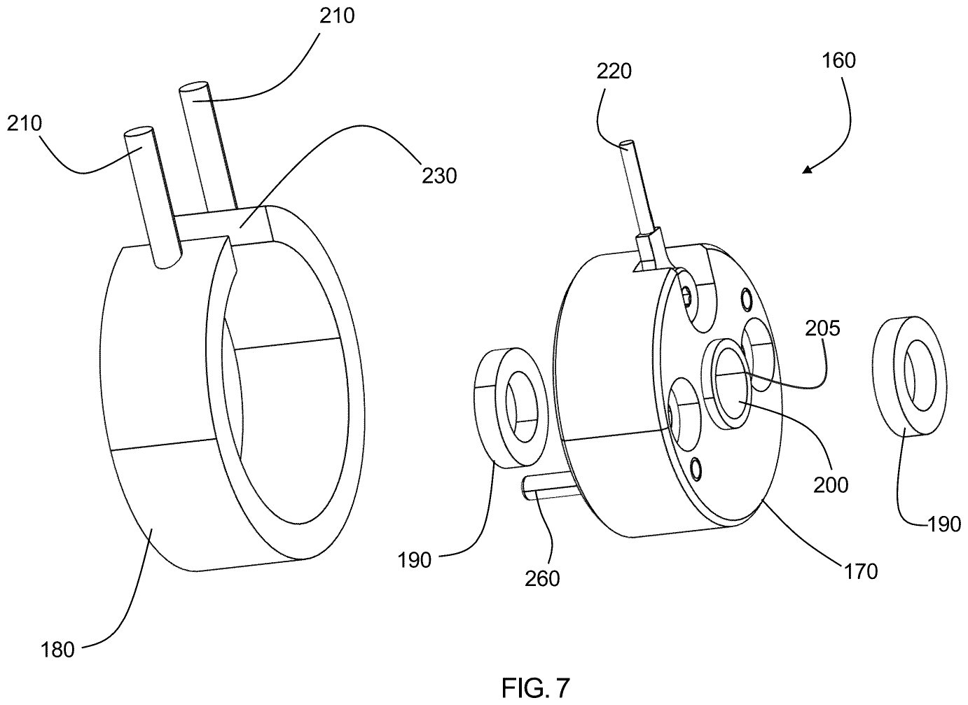

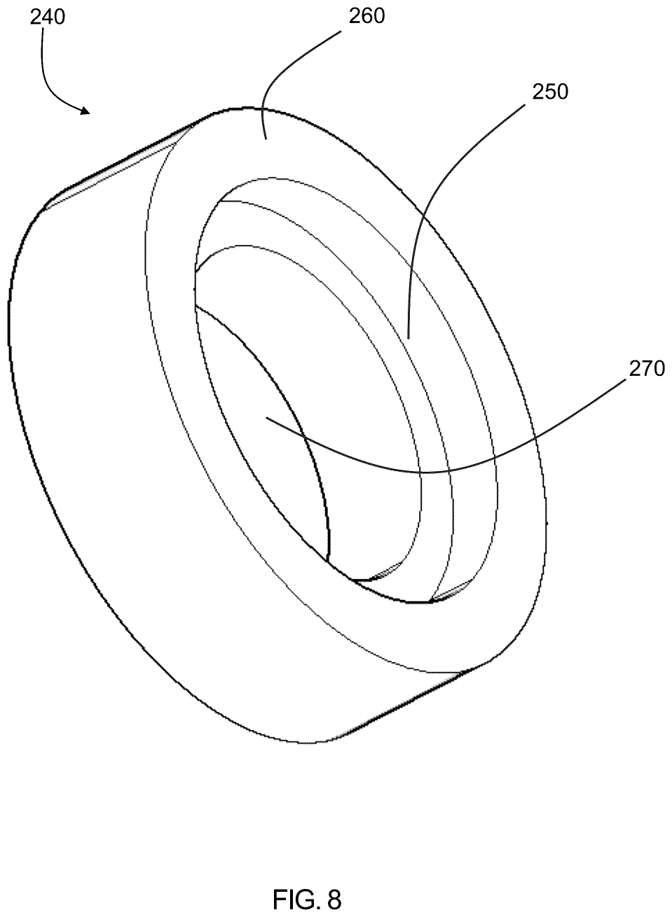

FIGS. 5 and 6 schematically illustrate perspective views of an exemplary heated runner separator 160, and FIG. 7 schematically illustrates an exploded view of the heated runner separator 160. The heated runner separator 160 includes a heated melt disc 170, a heating band 180, and a pair of insulator rings 190. The heated melt disc 170 includes a central aperture 200 through which one of the branches of the cold runner system 120 passes. Optionally, an annular protrusion 205 extends outward from the edge of the central aperture 200 on each side of the heated melt disc 170. The heating band 180 surrounds the outer circumference of the heated melt disc 170 and includes a pair of extended terminals 210. The extended terminals 210 can be attached to a heating source to heat the heating band 180, which then transfers heat to the heated melt disc 170. The heated melt disc 170 applies localized heat to the plastic in the cold runner system 120 so that the plastic located near the heated melt disc 170 remains molten or semi-molten during the cooling process. The insulator rings 190 are positioned on either side of the central aperture 200 passing through the heated melt disc 170 and, in one embodiment, are abutted to the annular protrusions 205 of the heated melt disc 170. It will be appreciated that such an arrangement localizes the heat and stops or limits the heat from traveling through the cold runner system 120 toward both the injection molding machine 110 and the mold cavities 140 and 150.

The heated runner separator 160 includes components for controlling the temperature of the heated melt disc 170 through a feedback loop. A thermocouple 220 is positioned in contact with the heated melt disc 170 to measure the temperature of the heated melt disc 170. The thermocouple 220 can pass through a gap 230 in the heating band 180 to maintain a compact profile for the heated runner separator 160. The thermocouple 220 is in communication with a controller (not shown). The controller compares the measured temperature to a target temperature. If the measured temperature is below the target temperature, the controller sends a signal to a heating source (not illustrated) to apply more heat to the heating band 180, which will elevate the temperature of the heated melt disc 170. Conversely, when the controller compares the measured temperature to the target temperature, if the measured temperature is above the target temperature, the controller sends a signal to the heating source to cease applying heat to the heating band 180, which will lower the temperature of the heated melt disc 170. In one embodiment, a single controller can be configured to monitor and adjust one or more heated runner separators 160 and may be configured to create multiple temperature zones by apply different target temperatures to different heated runner separators 160 based on the specific circumstances regarding the position and placement of a heated runner separators 160. In other embodiments, multiple controllers can be used to control multiple heated runner separators.

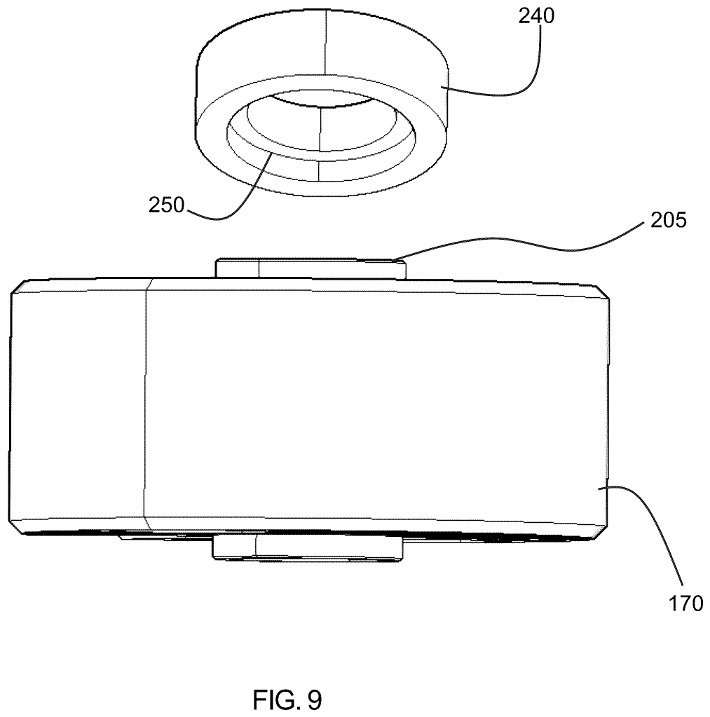

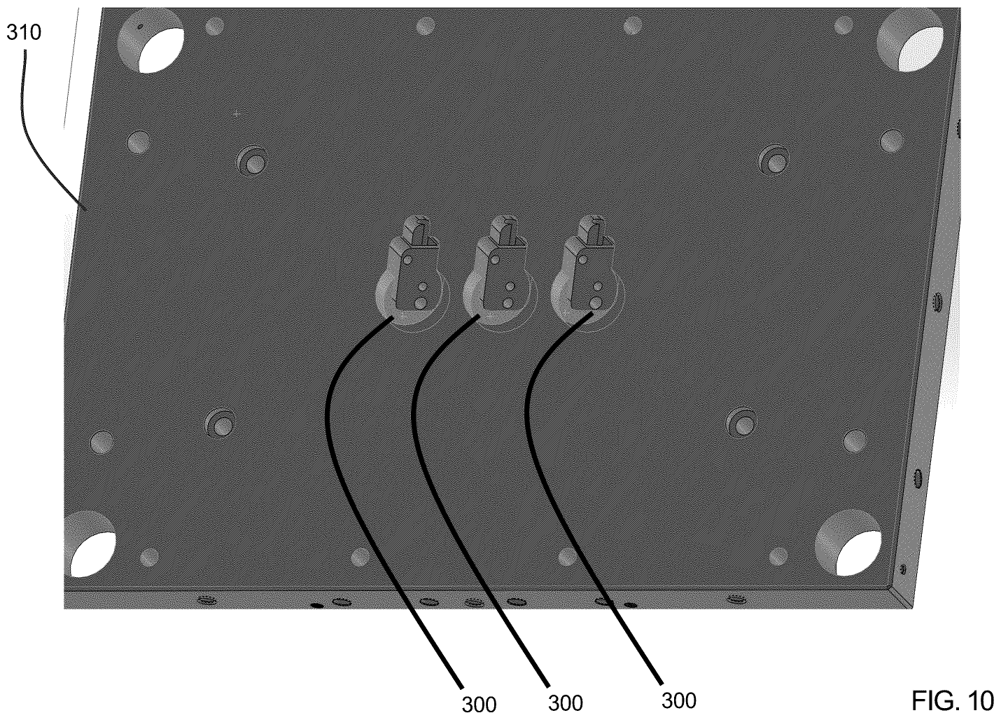

FIGS. 8 and 9 schematically illustrates an alternative arrangement for an insulator ring 240. In contrast to the insulator ring 190 described and illustrated above, the alternative insulator ring 240 includes an internal circumferential recession 250 on one end 260 of the insulator ring 240. The end 260 of the insulator ring 240 with the internal circumferential recession 250 is positioned in contact with the heated melt disc 170 when the heated runner separator 160 is assembled. Specifically, the internal circumferential recessions 250 is arranged to fit over the annular protrusions 205 on each side of the heated melt disc 170, respectively. In one embodiment, the fit between the internal circumferential recessions 250 and the annular protrusions 205 is a slight friction fit. When the heated runner separator 160 is fully assembled and installed, a branch of the runner passes through the internal aperture 270 of the insulator ring 240, and the engagement of the internal circumferential recession 250 and annular protrusion 205 prevents or limits leakage of plastic coming from the runner.

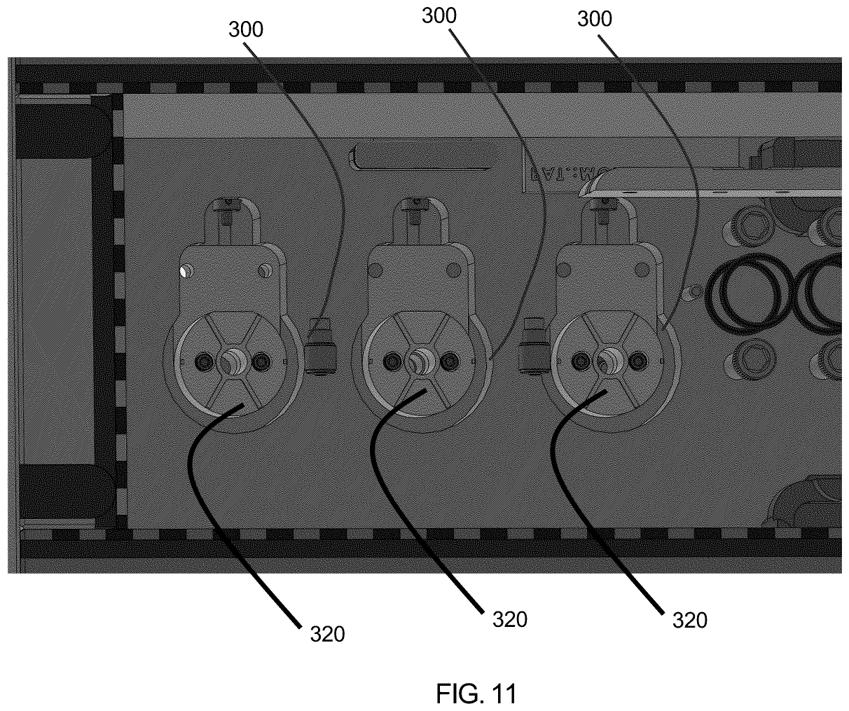

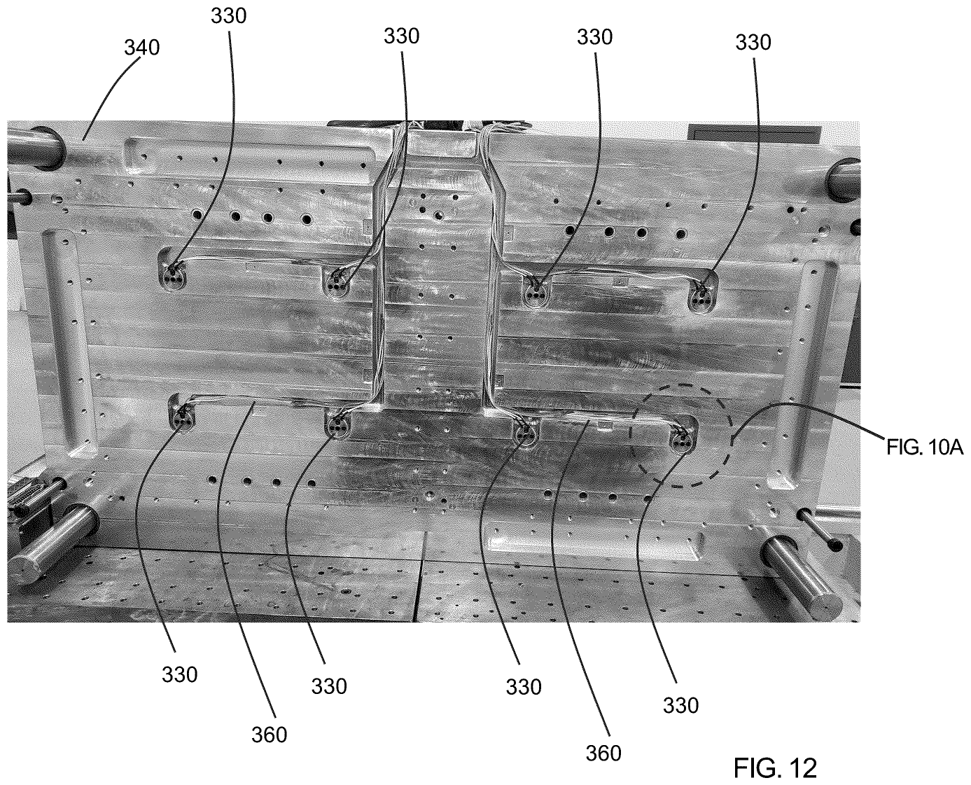

FIG. 10 schematically illustrates three machined out pockets 300 machined into the “A-side” of a mold plate 310. The pockets 300 are machined into the surface that is opposite the cavity of the mold. The pockets 300 are arranged to accommodate a heated runner separator. Each pocket 300 can be machined such that the heated runner separator sits flush with the surface of the mold plate 310 when positioned within the pocket 300. In another embodiment, the pocket 300 can be machined such that the heated runner separator is recessed below the surface of the mold plate 310 when positioned within the pocket 300. FIG. 11 schematically illustrates three heated runner separator 320 positioned in the three pockets 300.

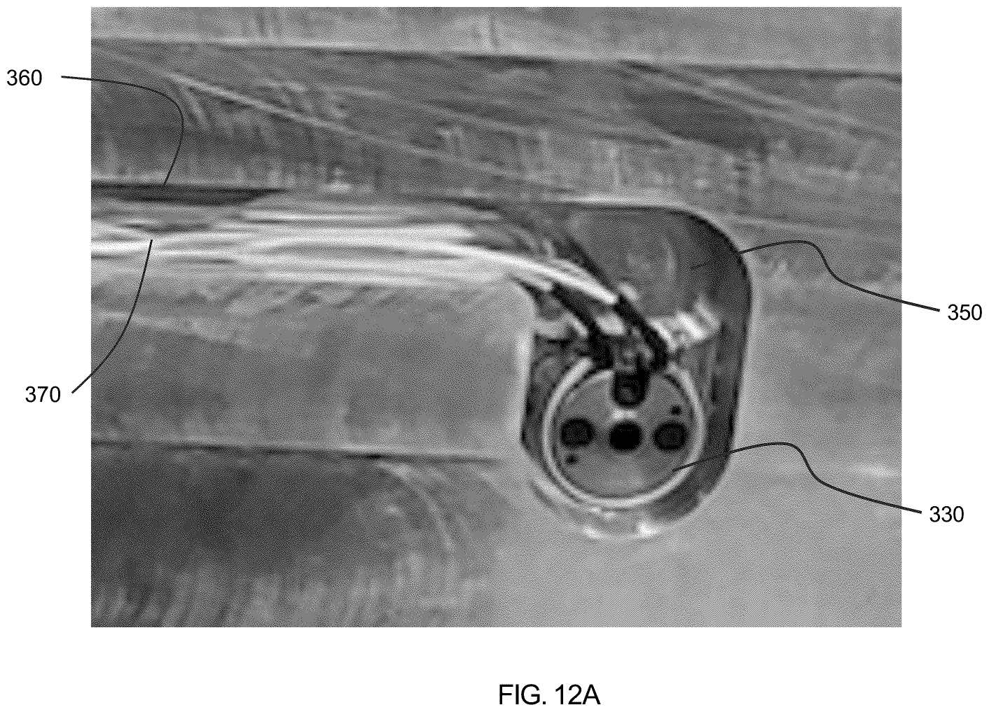

FIGS. 12 and 12A are photographs depicting an embodiment with eight heated runner separators 330 incorporated into the pockets 350 formed in the outer surface of the A-side of a mold cavity 340. FIG. 12A is a detailed view of the photograph of FIG. 12 depicting a single heated runner separator 330. As will be understood, such an arrangement can accommodate an injection molding process that forms a pair of molded parts, each with four drops for the injection of thermoplastic polymer into each cavity, per each injection cycle. Alternatively, this arrangement can accommodate an injection molding process that forms four molded parts, with two drops for the injection of thermoplastic polymer into the cavity, per each injection cycle. Alternatively, this arrangement can accommodate an injection molding process that forms a single molded part, with eight drops for the injection of thermoplastic polymer into the cavity, per each injection cycle. In another alternative, this arrangement can accommodate an injection molding process that forms eight molded parts, each with one drop for the injection of thermoplastic polymer into each cavity, per each injection cycle. The foregoing embodiments are exemplary embodiments, and it will be understood that the mold plates and cavities can be arranged in numerous ways to accommodate the requirements of the molded product.

To accommodate each heated runner separator 330, an area of the surface of the mold plate 340 is machined out to form a pocket 350 so that the heated runner separator 330 can be positioned flush with or below the outer surface of the mold plate 340. The general shape of the pocket 350 generally matches the profile of the heated runner separator 330. However, in certain embodiments, such as those illustrated in FIGS. 12 and 12A, the pocket 350 is larger than the heated runner separator 330. Such an arrangement creates an air gap between the outer circumference of the heated runner separator 330 and the inner circumference of the pocket 350. This air gap acts as an insulator to stop or limit heat from being transferred laterally from the heated runner separator 330 to the mold plate 340 or any other part of the injection molding system. Additionally, if the pocket 350 is machined such that the heated runner separator 330 is positioned below the outer surface of the mold plate 340, an additional air gap can be created above the heated runner separator 330 to further act as an insulator to stop or limit heat from being transferred from the heated runner separator 330 to the mold plate 340 or any other part of the injection molding system. As will be discussed subsequently, additional insulating techniques can be used to manage heat such that heat is not transferred from the heated runner separator 330 or any of its components to the mold plates or any other part of the injection molding system.

Additionally, pathways 360 can be machined into the mold plate 340 to accommodate wiring 370 required to communicate with the heated runner separator 330. Such wiring 370 includes leads from the controller that attach to the terminals 210 and leads from the controller to the thermocouple 220 of the heated runner separator 330.

Generally, with reference to FIGS. 10-12A, heated runner separator can be secured to a mold cavity with a pair of fasteners 234, such as those illustrated in FIGS. 5 and 6. Additionally, the heated runner separator 160 can include a pair of rods 236 (illustrated in FIG. 6) that can match a pair of holes in the mold cavity that assure proper alignment of the heated runner separator relative to the cold runner system and mold cavity.

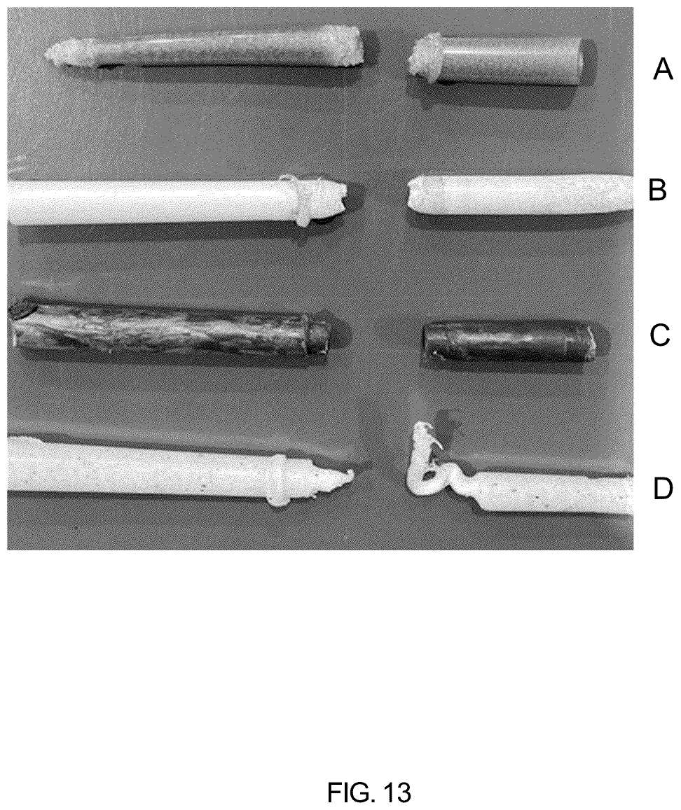

FIG. 13 is a photograph of a number of plastic runners of different plastic materials separated by a heated runner separator. The plastic runners in FIG. 13 include thermoplastic polyurethane (A), polyvinyl chloride (B), a blend of high impact polystyrene and general purpose polystyrene (C), and a blend of polypropylene and low density polypropylene (D).

In one exemplary method, the target temperature of a heated runner separator is set to a temperature that is about the glass transition temperature for the plastic. In another exemplary method, the target temperature of the heated runner separator is set to a temperature that is slightly below the melt temperature for the plastic. However, the specific target temperature for the heated runner separator is dependent on several factors such as, for example, type of plastic, sprue thickness, runner thickness, shot size, and time between injection cycles.

It will be appreciated that the novel heated runner separators disclosed herein provides many advantages for injection molding processes. For example, when using techniques for foaming plastics, the use of heated runner separators provides for the plastic processed through the runner system to maintain its foamed properties, which results in a molded part with the desired lower density and/or structure. The overall injection molding system is less expensive to manufacture and maintain when using heated runner separators. In comparison to hot runner systems, which can cost several hundreds of thousands of dollars, a heated runner separator can be manufactured and installed for a fraction of that cost. The use of cold runner systems with heated runner separators results in less wear and tear on the overall injection molding system and switch overs to other plastic, particularly plastics of different colors, is significantly quicker and easier. In addition, hot runner systems are relatively large and bulky, and typically occupies significant space between the mold cavity and injection molding machine. Since an injection molding system has a finite amount of space, the larger the runner system, the less space is left for the mold cavities that form the molded part. Thus, hot runner systems typically place restrictions on the maximum size of molded parts. Cold runner systems with heated runner separators do not have such restrictions.

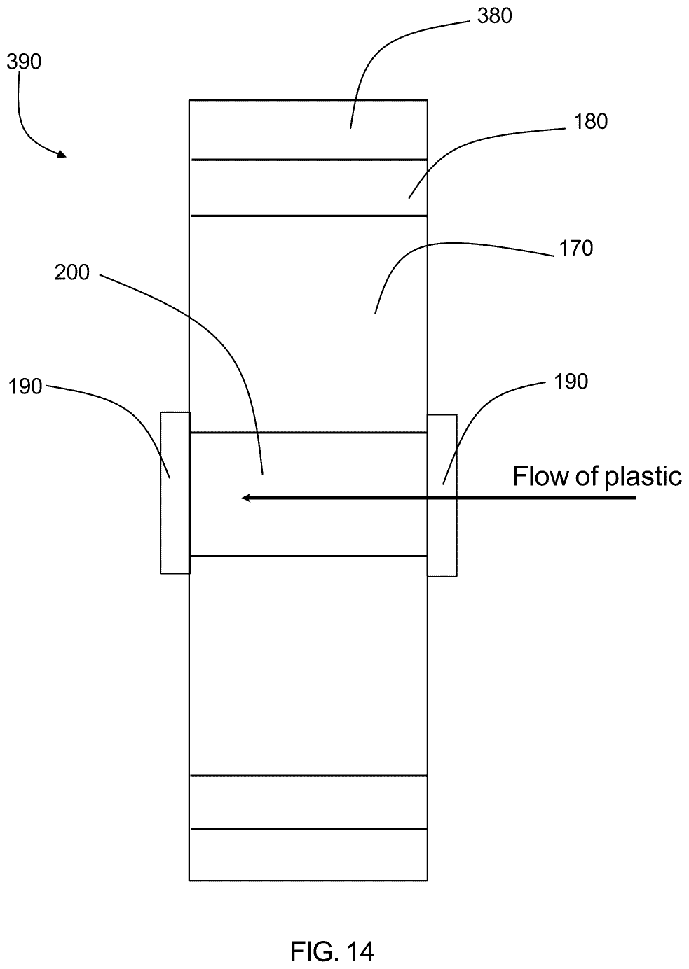

As described herein, a heated runner separator includes a pair of insulator rings to isolate the heated melt disc from the remainer of the cold runner system and the mold plates. However, additional insulating elements and techniques may be added to the heated runner separator to further isolate the heated runner separator from the remainder of the injection molding system. For example, as illustrated in cross section in FIG. 14, an additional insulator layer 380 can be added to a heated runner separator 390. The insulator layer 380 is wrapped around the outer surface of the heating band 180. It will be appreciated that the insulator layer 380 stops or limits heat transfer to the mold plate when the heated runner separator 390 is positioned within the mold plate.

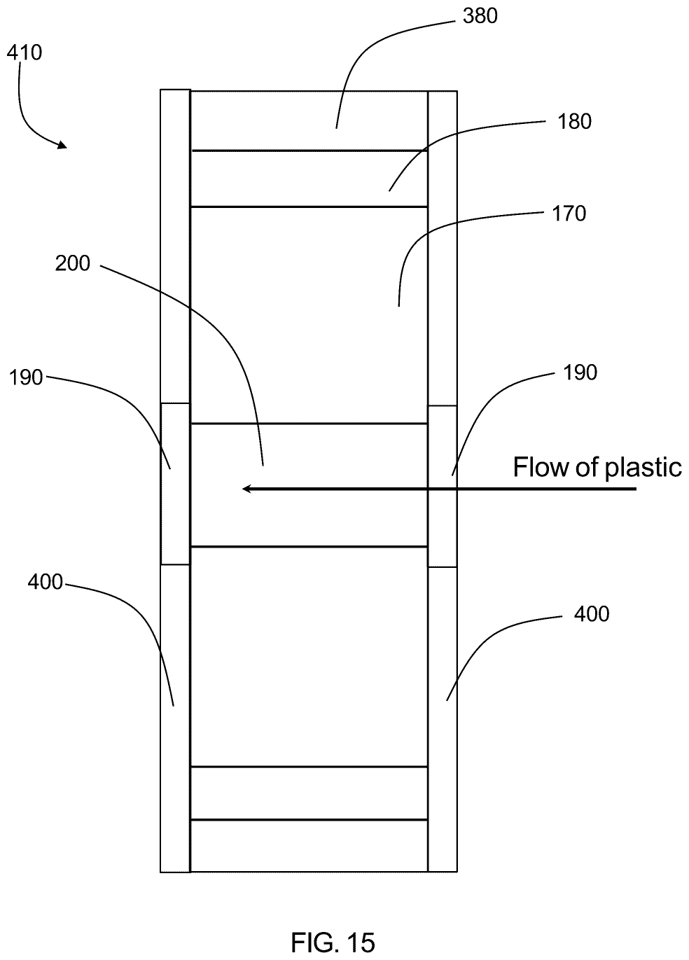

In another example, as illustrated in cross-section in FIG. 15, in addition to an insulator layer 380, two insulator panels 400 can be added to the two faces of the heated runner separator 410. It will be appreciated that the addition of the two insulator panels 290 stops or limits heat transfer on the one side to the mold plate when the heated runner separator 280 is positioned in the mold plate and stops heat transfer on the other side to the remainder of the cold runner system.

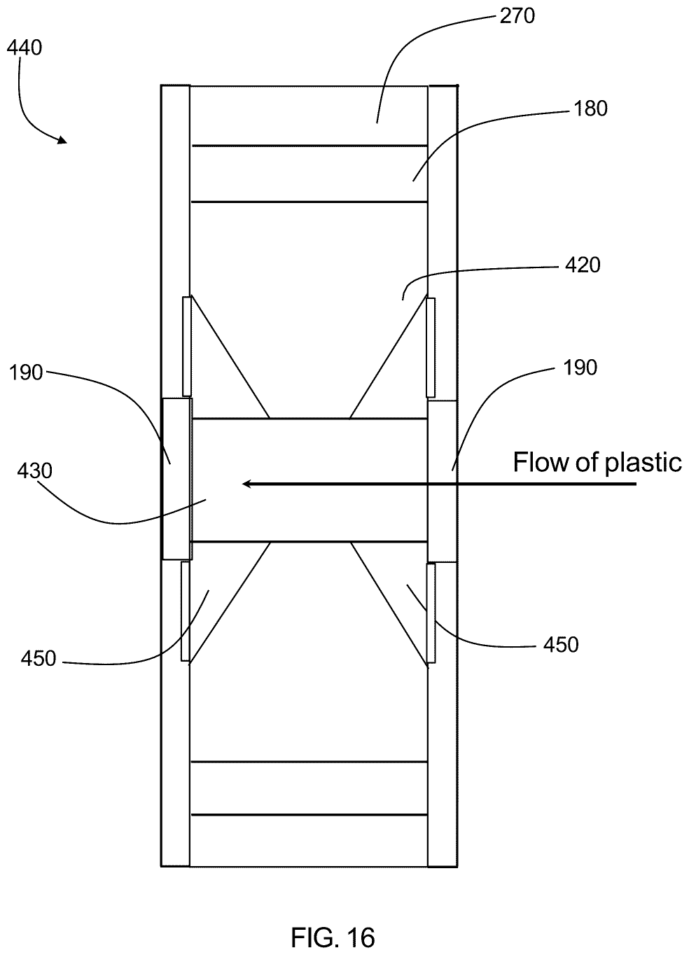

In another example, as illustrated in cross-section in FIG. 16, a heated melt disc 420 is tapered to narrow at the location where it engages its central aperture 430. Such tapering of the heated melt disc 420 further concentrates heat applied to the plastic material in the cold runner system. Such additional concentration may result in a reduction in the energy required to achieve separation of the plastic runners in the cold runner system. The heated runner separator 440 including insulator panels 450 shaped to fully insulate the heated runner separator 440.

Additional techniques to enhance heat management and insulate the remainder of the injection molding system from heat generated from a heated runner separator are described below. The fasteners 234 used to secure a heated runner separator 160 to a mold plate can be arranged to limit heat migrating through the fasteners 234. For example, an insulating washer can be placed between the head of the fastener 234 and the heated melt disc 170 to limit heat transfer from the heated melt disc 170 to the fastener 234. As illustrated in FIG. 5, the heated melt disc 170 can include a countersunk portion to accommodate the head of the fastener 234. An additional insulating washer can also be placed on the fastener 234 on the opposite side of the heated melt disc 170 between the heated melt disc 170 and the mold plate to limit heat transfer from the heated melt disc 170 to the mold pate. Additionally, the passageway in the heated melt disc 170 through which the fastener 234 passes can have a larger inner diameter than the outer diameter of the fastener 234, which creates an air gap between the heated melt disc 170 and the fastener 234 that limits the heat transferred from the heated melt disc 170 to the fastener 234. Alternatively, the passageway can be arranged to be large enough to accommodate the fastener 234 and an insulating sleeve positioned around the fastener 234 to further limits the heat transferred from the heated melt disc 170 to the fastener 234. In yet another alternative, an insulating coating can be applied to the fastener 234 to limit the heat transferred from the heated melt disc 170 to the fastener 234. Similar techniques can be used to limit heat transferred to the pair of rods 236 used to align the heated runner separator with the molding block. The inner diameters of the passageways made in the mold plate for the rods 236 can be larger than the outer diameter of the rods 236 (since the rods 236 can be arranged for general alignment the heated runner separator and not precise alignment the heated runner separator) and deeper than the length of the rods 239, thus creating an air gap around the rods 236 that insulates the rods 236 from direct contact with the mold plate. The pair of rods 236 can also include insulation sleeves or insulating coating.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A heated runner separator comprising:
a heated melt disc with a central aperture;
a heating band positioned around the heated melt disc;
a first insulator ring positioned proximate to a first end of the central aperture of the heated melt disc; and
a second insulator ring positioned proximate to a second and opposite end of the central aperture of the heated melt disc.

2. The heated runner separator of claim 1, further comprising a first terminal and second terminal extending from the heating band and arranged to be coupled to a heating source to heat the heating band.

3. The heated runner separator of claim 2, further comprising a thermocouple in contact with the heated melt disc and arranged to measure the temperature of the heated melt disc.

4. The heated runner separator of claim 3, further comprising a controller in communication with the thermocouple and the heating source.

5. The heated runner separator of claim 4, wherein the controller is arranged to compare the temperature of the heated melt disc to a target temperature and if the temperature of the heated melt disc is lower than the target temperature, the controller sends a signal to the heating source to apply heat to the heating band

6. The heated runner separator of claim 5, wherein if the temperature of the heated melt disc is higher than the target temperature the controller sends a signal to the heating source to cease the application of heat to the heating band.

7. The heated runner separator of claim 1, further comprising an insulator layer positioned around heating band.

8. The heated runner separator of claim 1, further comprising:
a first insulation panel positioned on a first face of the heated runner separator; and
a second insulation panel positioned on a second and opposite face of the heated runner separator.

9. The heated runner separator of claim 1, wherein the heated melt disc is tapered proximate to the central aperture.

10. The heated runner separator of claims 1, wherein the heated runner separator is positioned around a runner of a cold runner system.

11. The heated runner separator of claim 1, wherein the heated melt disc includes a first annular protrusion on a first side of the the heated melt disc extending outward from a first edge of the central aperture and a second annular protrusion on a second and opposite side of the heated melt disc extending outward from a second and opposite edge of the central aperture.

12. The heated runner separator of claim 11, wherein the first insulator ring is abutted to the first annular protrusion and the second insulator ring is abutted to the second annular protrusion.

13. The heated runner separator of claim 11, wherein:
the first insulator ring includes an internal circumferential recession on one end of the second insulator ring;
the second insulator ring includes an internal circumferential recession on one end of the second insulator ring;
the first annular protrusion of the heated melt disc is positioned in the circumferential recession of the first insulator ring; and
the second annular protrusion of the heated melt disc is positioned in the circumferential recession of the second insulator ring.

14. The heated runner separator of claim 13, wherein the positioning of the first annual protrusion of the heated melt disc in the circumferential recession of the first insulator ring and the positioning of the second annual protrusion of the heated melt disc in the circumferential recession of the second insulator ring are friction fits.

15. The heated runner separator of claim 1, wherein the heated runner separator is positioned in a pocket formed in a mold plate of an injection molding system.

16. A method of separating a plastic runner in a cold runner system during an injection molding process includes the steps of:
positioning a heated runner separator around a section of a runner in a mold of an injection molding system to provide localized heat to the section of the runner;
insulating the heated runner separator to limit the transfer of heat from the heated runner separator to other portions of the injection molding system; and
maintaining the heated runner separator at a temperature that will maintain plastic in the runner proximate to the heated runner separator in at least a semi-molten state;
wherein when plates of the mold are separated, the plastic runner separates at a location proximate to the heated runner separator.

17. The method of claim 16, wherein the heated runner separator is positioned proximate to an injection point of the mold.

18. The method of claim 17, wherein a heated runner separator is positioned proximate to each injection point of the mold.

19. The method of claim 16, wherein the step of maintaining the heated runner separator at a temperature that will maintain plastic in the runner proximate to the heated runner separator in at least a semi-molten state is accomplished through the use of a controller, a heating source coupled to the controller and the heated runner separator, and a thermocouple coupled to the controller and the heated runner separator, wherein the controller uses a feedback loop using information provided by the thermocouple to send a signal to the heating source to increase or decrease the heat provided to the thermocouple based on the information provided by the thermocouple.

20. The method or claim 16, wherein the step of insulating the heated runner separator to limit the transfer of heat from the heated runner separator to other portions of the injection molding system is accomplished through the use of at least one of an insulator layer, one or more insulator panels, one or more insulating washers, one or more insulating sleeves, or insulating coatings.
